(19) United States
(12) Patent Application Publication
(10) Pub. No.: US 2026/0336750 A1
(43) Pub. Date: Oct. 29, 2026

(54) Operating Device for a Bottom-Bracket Drive of an Electric Bicycle, Method for Controlling the Bottom-Bracket Drive, and Electric Bicycle

(71) Applicant: ZF Friedrichshafen AG, Friedrichshafen (DE)

(72) Inventors: Alexander Jungaberle, Schlier (DE); Uwe Schraff, Markdorf (DE); Markus Wallner, Friedrichshafen (DE)

(21) Appl. No.: 19/115,995

(22) PCT Filed: Sep. 29, 2022
(86) PCT No.: PCT/EP2022/077172

§ 371 Date: Mar. 27, 2025

(51) Int. Cl. B62M 25/04; B62M 6/40; B62M 9/132

(52) U.S. Cl. CPC B62M 25/04; B62M 6/40; B62M 9/132

(57) ABSTRACT

An operating unit for a bottom bracket drive of an electric bicycle is attachable to a handlebar of the bicycle at a handlebar grip and includes at least one actuating element movable, starting from a neutral position, in either a first actuation direction or in a second actuation direction at a time by a finger of a user. Each particular actuating element is movable, in either actuation direction, from the neutral position into at least two functional positions arranged one after another, and returns to the neutral position when released. A first actuating force is required to move the particular actuating element into a first functional position of the at least two functional positions, and a second, greater actuating force is required to overcome a noticeable pressure point and to move the particular actuating element into at least one second functional position of the at least two functional positions.

### CROSS-REFERENCE TO RELATED APPLICATION

The present application is a nationalization of PCT/EP2022/077172 filed in the European Patent Office on Sep. 29, 2022, the entirety of which is incorporated by reference for all purposes.

### FIELD OF THE INVENTION

The present invention relates generally to an operating unit for a bottom bracket drive that includes one or more actuating elements. The invention further relates to a method for actuating the bottom bracket drive and to an electric bicycle.

### BACKGROUND

In known electric bicycles, operating elements for actuating a drive, in particular for shifting gear steps, are known, which operating elements can be push buttons, levers, trigger shifters, or the like. In addition, derailleurs are known, which implement gear changes both mechanically, for example using a shift cable, and electrically, in particular in a wireless or hard-wired manner. Further bicycle gear-change systems are hub gears or transmissions with shifting devices. The shifting mechanism that is used is a shift lever, in particular a trigger shifter, or even a rotary shifter. Derailleurs with trigger shifters, which are actuated by a thumb of the bicycle rider, are the most widespread. In addition, mode change switches are known from the prior art, with which, via the press of a thumb, for example, electric motor assistance can be selected, or a walk mode of the bicycle or the headlight can be activated or deactivated.

DE 10 2015 216 186 B4 describes, for example, a remote control unit for the display unit of an electric bicycle. The remote control unit is located in the region of a handlebar grip remote from the display unit and has assistance selection buttons for selecting the assistance level and at least one input device for navigating the menu and selecting menu items displayed on the display unit. The input device and the assistance selection buttons are arranged along a convex arcuate common line with respect to the handlebar grip.

### SUMMARY OF THE INVENTION

The problem addressed by the present invention is that of describing an operating unit or “operating drive” for a bottom bracket drive that has improved operability and is more ergonomic.

According to a first aspect of the invention, an operating unit according to the invention for a bottom bracket drive of an electric bicycle is provided. The operating unit is configured to be attached to a handlebar of the electric bicycle in the region of a handlebar grip. The operating unit has at least one actuating element which, starting from a neutral position in each case, is movable in a first actuation direction and in a dissimilar, second actuation direction, for instance, by a finger, in particular the thumb, of a user. The particular actuating element is movable, in each of the two actuation directions, from the neutral position into at least two functional positions, which are arranged one after the other, and, when released, returns to the neutral position thereof, wherein a first actuating force is necessary to reach a first functional position, and a noticeable pressure point is to be overcome by a second actuating force to reach at least one second functional position, which second actuating force is greater in comparison to the first actuating force. The particular actuating element is a trigger shifter, which can be actuated via manual actuation by the bicycle rider or the user and in accordance with the actuating force from the neutral position in two actuation directions, specifically either in the first actuation direction or in a second actuation direction at a time. After each actuation, the particular actuating element returns to the starting position or the neutral position. A spring mechanism or the like can be used for this purpose.

In both actuation directions, there are preferably two, alternatively three, four, or more than four functional positions arranged one after the other, which functional positions are tangibly separated from one another, by pressure points, during the actuation by the bicycle rider. From the neutral position, the user reaches the first functional position by actuating the particular actuating element with the first actuating force, which is less than the force that is required to overcome or move through the first pressure point. From the neutral position and/or the first functional position, the user reaches the second functional position by applying a second actuating force, which is at a level that is required to overcome the first pressure point. If a third functional position is provided, in order to reach the third functional position, a third actuating force is required such that a second pressure point, which tangibly separates the second and the third functional positions, is overcome. The more functional positions there are that are arranged one after the other, the greater is the actuating force that is required to reach the particular functional position. As a result, the user can directly feel which functional position it is that they are in. It is conceivable that the pressure points at three or more functional positions are each to be overcome using the same second actuating force. Therefore, a higher functional position can be reached comparatively easily and with comparatively less actuating force. Thus, the particular actuating element is actuated when the user of the electric bicycle applies pressure using one of their fingers onto the particular actuating element, specifically such that the actuating element moves in the first actuation direction or in the second actuation direction. The particular pressure point is haptic feedback as a perceptibly changed resistance during the actuation of the particular actuating element in the first or the second actuation direction.

Using such an operating unit, for example, single-gear shifts or multiple-gear shifts can be carried out as an upshift or a downshift in a simple way without limitations and using only one actuating element. The gear changes can take place sequentially, i.e., in order. Thus, multiple gears or gear steps can be quickly changed in succession within a short period of time. Furthermore, it is conceivable that one or more gear steps are skipped over in multiple-gear shifts, which depends on a shifting unit of the bottom bracket drive or a transmission integrated in the bottom bracket drive.

Alternatively, it is conceivable that a first extent of lever travel is necessary to reach the first functional position and that a second extent of lever travel is necessary to reach the second functional position, which second extent of lever travel is more distant from the neutral position in comparison to the first extent of lever travel and is reached by overcoming a noticeable pressure point. The particular actuating element can be held at the particular extent of lever travel by a suitable detent for fixing the particular actuating element in the particular functional position in the first actuation direction or in the second actuation direction. The particular actuating element of the operating unit can therefore also be actuated in a manner depending on the extent of travel rather than depending on force. When different actuating forces are addressed in the framework of this invention, various extents of lever travel can also be used, as an alternative, to actuate the bottom bracket drive by the particular actuating element.

According to one exemplary embodiment, the particular actuating element is a shift rocker, wherein a first leg of the shift rocker is actuatable in the first actuation direction, and wherein a second leg of the shift rocker, which is integrally connected to the first leg, is actuatable in the second actuation direction. Alternatively, the particular actuating element is a shift lever. The shift lever can consist of two levers, buttons, or switches, which are actuatable in the particular actuation direction. The particular actuating element is haptically detectable by the user of the electric bicycle while riding.

The operating unit is attached to the handlebar of the electric bicycle such that the rider of the electric bicycle can actuate the particular actuating element by at least one of their fingers, in particular their thumb, wherein it is ensured at all times that they can firmly hold the handlebar grip using both hands. The advantage of the operating unit is basically that functions related to the propulsion of the electric bicycle can also be adjusted while riding due to the simple combination of button assignment and the association of the functional positions with functions related to the propulsion of the electric bicycle. As a result, the riding safety is substantially increased, wherein the operating unit can be intuitively operated due to the low number of buttons and a simple arrangement. The particular actuating element is therefore clear and easily comprehensible. The manually actuatable buttons of the particular actuating element are advantageously arranged on the handlebar of the electric bicycle one above the other in the direction of gravity, so that the particular actuating element is actuatable with a thumb of the bicycle rider.

According to one exemplary embodiment, the at least one actuating element is a first actuating element, wherein, according to an actuation of the first actuating element, the bottom bracket drive is activatable or activated such that the bottom bracket drive is upshifted in a stepwise manner by one gear step in each case by repeatedly actuating the first actuating element from the neutral position into the first functional position in the first actuation direction and, immediately thereafter, releasing the first actuating element, and the bottom bracket drive is downshifted in a stepwise manner by one gear step in each case by repeatedly actuating the first actuating element from the neutral position into the first functional position in the second actuation direction and, immediately thereafter, releasing the first actuating element.

The first actuating element is therefore understood to be a gear shifter which is actuatable in two actuation directions, each of which has at least two functional positions. The stepwise upshift or downshift is therefore achieved by briefly tapping the first actuating element in the particular actuation direction from the neutral position into the first functional position, each tap triggering a gear shift between two gear steps. A stepwise upshift or downshift is understood to mean that the gear steps are upshifted or downshifted in succession. Thus, tapping multiple times in the particular actuation direction from the neutral position into the first functional position effects a sequential upshift or downshift. In any gear step, a propulsive power is transmitted from an input, be it from an electric machine (electrical propulsion unit) and/or from a pedal drive (muscle-powered drive) onto the drive output, i.e., the corresponding wheel of the electric bicycle, with a certain transmission ratio. After the first actuating element has been tapped, the first actuating element is always released and returns from the particular functional position into the neutral position.

Preferably, the bottom bracket drive is activatable or activated according to an actuation of the first actuating element such that the bottom bracket drive is upshifted in a stepwise manner by two or more gear steps by repeatedly actuating the first actuating element from the neutral position into the second functional position in the first actuation direction and, immediately thereafter, releasing the first actuating element, and the bottom bracket drive is downshifted in a stepwise manner by two or more gear steps by repeatedly actuating the first actuating element from the neutral position into the second functional position in the second actuation direction and, immediately thereafter, releasing the first actuating element. Therefore, if the first actuating element is actuated past the first pressure point to the second functional position and therefore moves in the particular actuation direction, a double-or multiple-gear shift is carried out, depending on the assignment of functions. It is advantageous when a double gear shift is provided. If there is, for example, a third functional position, when the first actuating element is actuated past the second pressure point to the third functional position, for example, a triple gear shift can therefore be provided.

Preferably, the bottom bracket drive is activatable or activated according to an actuation of the first actuating element such that the bottom bracket drive is upshifted by three or more gear steps by actuating the first actuating element from the neutral position into the first functional position and/or the second functional position in the first actuation direction and holding the first actuating element in the first and/or the second functional position for a defined duration, and such that the bottom bracket drive is downshifted by three or more gear steps by actuating the first actuating element from the neutral position into the first functional position and/or the second functional position in the second actuation direction and holding the first actuating element in the first and/or the second functional position for a defined duration.

Holding the particular actuating element in a certain functional position is understood to mean pressing or actuating the particular actuating element for a long time, which triggers a certain shifting function. In any case, holding the particular functional position lasts longer than the above-described tapping of the particular actuating element. Pressing for a long time can be, for example, an actuating duration of more than 500 ms (milliseconds), preferably more than 1000 ms. The holding duration which triggers the particular function is freely selectable and adjustable.

For example, holding the first actuating element in the first functional position and for a certain duration can trigger a single gear shift between two gear steps. The longer the first actuating element is held in the first functional position, the more frequently is a single gear shift carried out. In particular, pressing and holding the first actuating element in the first functional position in the first actuation direction can trigger an upshift from a first gear step into a second gear step, a third gear step, a fourth gear step, and so forth, in succession. Conversely, pressing and holding the first actuating element in the first functional position in the second actuation direction can trigger a downshift from, for example, a fifth gear step into a fourth gear step, a third gear step, a second gear step, and so forth, in succession.

Alternatively, or additionally, the at least one actuating element is a second actuating element, wherein the bottom bracket drive is activatable or activated according to an actuation of the second actuating element such that a function influencing an operating mode of the electric bicycle is adjustable and/or activatable by actuating the second actuating element from the neutral position into the first functional position and/or the second functional position in the first actuation direction and, thereafter, releasing the second actuating element, such that the function influencing the operating mode of the electric bicycle is adjustable and/or deactivatable by actuating the second actuating element from the neutral position into the first functional position and/or the second functional position in the second actuation direction and, thereafter, releasing the second actuating element.

The second actuating element is therefore understood to be a mode change switch which is actuatable in two actuation directions, each of which has at least two functional positions. The adjustment, activation, or deactivation of the particular operating mode of the electric bicycle is carried out in this case by briefly tapping the second actuating element in the particular actuation direction from the neutral position into the first functional position, each tap transmitting a corresponding input command to a control unit or the like, which can influence the operating modes of the electric bicycle and carries out the function influencing the operating mode of the electric bicycle.

The particular function influencing the operating mode of the electric bicycle is preferably an adjustment or selection of a defined propulsion assistance by an electric machine, which is drivingly connected to the bottom bracket drive, the adjustment or selection of a recuperation level of the bottom bracket drive, the selection of a shifting characteristic in the bottom bracket drive, the activation or deactivation of a walk-assist function of the electric bicycle, and/or the activation or deactivation of a front headlight and/or taillight of the electric bicycle. In other words, by actuating the second actuating element, for example, the type and/or intensity of the propulsion assistance and/or the type and/or intensity of the recuperation can be influenced according to the actuation direction and according to the functional position in the particular actuation direction. Furthermore, the type of gear changes can be adjusted by the second actuating element according to the actuation direction and according to the functional position in the particular actuation direction. In particular, the shifting characteristics can be subdivided at least into sporty shifting and comfortable shifting. In a sporty shifting characteristic, the gear shift is carried out immediately after the actuation of the first actuating element. In a comfortable shifting characteristic, the gear shift is initiated immediately after the actuation of the first actuating element, but is carried out only once the motor engages. In a particularly comfortable shifting characteristic (for example, “Komfort Plus”), the gear shift is initiated immediately after the actuation of the first actuating element, but is carried out only once the pedal crank of the pedal drive is located at dead center.

Furthermore, an automatic mode of the bottom bracket drive can be activated or deactivated, in which automatic mode, in particular, gear changes are carried out automatically or according to certain riding states or operating states. Furthermore, a front headlight and/or a taillight of the electric bicycle can be activated, i.e., switched on, or deactivated, i.e., switched off, by using the second actuating element according to the actuation direction and according to the functional position in the particular actuation direction. In addition, a walk-assist function can be activated, i.e., switched on, or deactivated, i.e., switched off, by using the second actuating element according to the actuation direction and according to the functional position in the particular actuation direction. The walk-assist function can also be used as a start-up assist function. After the second actuating element has been tapped, the second actuating element is always released and returns from the particular functional position into the neutral position.

Preferably, the bottom bracket drive is activatable or activated according to an actuation of the second actuating element such that a further function influencing an operating mode of the electric bicycle is adjustable or activatable by actuating the second actuating element from the neutral position into the first functional position and/or the second functional position in the first actuation direction and holding the second actuating element in the first functional position and/or the second functional position for a defined duration, such that the further function related to the operating mode or the manner of use of the electric bicycle is adjustable or deactivatable by actuating the second actuating element from the neutral position into the first functional position and/or the second functional position in the second actuation direction and holding the second actuating element in the first functional position and/or the second functional position for a defined duration. The more functional positions there are that are provided and are actuatable using the second actuating element, the more different functions influencing the operating mode of the electric bicycle there are that can be carried out or initiated. With respect to holding the particular actuating element in a certain functional position, reference is made to the preceding comments.

The operating unit can have only the first actuating element. Alternatively, the operating unit can have only the second actuating element. Further alternatively, the operating unit can have both the first actuating element and the second actuating element.

If two actuating elements are provided, these can be located on the handlebar such that the first actuating element is located on the left handlebar grip in the forward direction of travel and is actuatable by a finger, preferably the thumb, of the left hand of the bicycle rider, whereas the second actuating element is located on the right handlebar grip in the forward direction of travel and is actuatable by a finger, in particular the thumb, of the right hand of the bicycle rider, or vice versa. It is also conceivable that the two actuating elements are jointly located on the left or the right handlebar grip of the handlebar of the electric bicycle and, correspondingly, are actuatable by a single finger, preferably the thumb, of the particular hand of the bicycle rider. The actuating elements can therefore be located next to one another transversely to the longitudinal direction of the bicycle.

According to a second aspect of the invention, in a method according to the invention for activating a bottom bracket drive of an electric bicycle, including an operating unit for activating the bottom bracket drive, wherein the operating unit has at least one actuating element which is movable in each case from a neutral position by a finger, in particular the thumb, of a user in a first actuation direction and in a dissimilar, second actuation direction, the particular actuating element is movable, in each of the two actuation directions, from the neutral position into at least two functional positions arranged one after the other and, when released, returns to the neutral position of the actuating element, wherein a first actuating force is required to reach a first functional position and a noticeable pressure point is to be overcome by a second actuating force, which is greater in comparison to the first actuating force, to reach at least one second functional position. With respect to the method, reference is made to the comments and examples provided in the preceding sections of the description.

According to a third aspect of the invention, an electric bicycle according to the invention has a handlebar with two handlebar grips, at least one front wheel, and at least one rear wheel, wherein the front wheel and/or the rear wheel is at least indirectly drivingly connected to the bottom bracket drive, wherein an operating unit according to the first aspect of the invention is located on the handlebar, which operating unit is electronically connected to the bottom bracket drive. The front wheel and/or the rear wheel can be operatively connected, for example, via a chain or a belt, to a driving component at the drive output of the bottom bracket drive. The electric bicycle can be a bicycle which is propelled purely by an electric motor, i.e., an e-bike, or a bicycle which is propelled partially by muscle power and partially by an electric motor, i.e., a pedelec.

The handlebar includes the handlebar frame and the handlebar grips, wherein the handlebar frame is pivotably arranged on the remaining frame of the electric bicycle, and wherein the handlebar grips are designed such that the rider of the electric bicycle can grasp these and support themself thereon. The operating unit with the particular actuating element is located on the handlebar such that the rider does not need to remove the hand from the handlebar grip to actuate the particular actuating element.

A bottom bracket drive of the electric bicycle can be understood to mean either a purely electric-motor drive (e-bike) or a drive operated in a hybrid mode using muscle power (pedelec). Therefore, the bottom bracket drive can be used for e-bikes and for pedelecs. The bottom bracket drive preferably has a drive motor, in particular as an electric machine, and a transmission. A drive motor as an electric machine has a stator secured to the housing and a rotor mounted for rotation with respect to the stator. The rotor is drivingly connected to the transmission. The transmission is operatively connected at least indirectly to a crank axle of the electric bicycle via a first transmission element and at least indirectly to a chainring or belt cog of the electric bicycle via a second transmission element. The transmission can be a planetary transmission having at least one planetary gear set, wherein the particular planetary gear set includes the gear set elements sun gear, ring gear, and planet carrier. Each of these gear set elements is understood to be a transmission element in the sense of this invention. The transmission also has shift elements for implementing different gear steps. The bottom bracket drive can also have an open-loop and closed-loop control unit, which receives the input commands generated via the particular actuating element of the operating unit and converts these into corresponding open-loop and closed-loop control commands at the electric motor and/or at the transmission of the bottom bracket drive.

The bottom bracket drive also includes a transmitter and receiver unit, which communicates with an external device, in particular a computer or a smartphone. Via the transmitter and receiver unit, configurations can be implemented at the operating unit. In particular, the button assignment can be adapted to the preferences of the user.

Furthermore, it is possible to adjust the durations for which the particular actuating element is held in the particular functional position, which durations indicate that certain functions or commands are to be carried out. In addition, the pressure points, in particular the actuating force of the particular pressure point that must be applied, can be adjusted. In other words, the button and pressure-point assignment can be freely configured, even retroactively.

Preferably, the bottom bracket drive also includes means for decoupling a kinematic energy from the chainring or belt cog, which kinematic energy is usable for recuperation. Such a means for decoupling can be, for example, a freewheel unit which decouples kinematic energy from the chainring or belt cog, which kinematic energy is usable for recuperation. Therefore, electrical energy can be recovered, which electrical energy is generated in the coasting operation of the electric bicycle and delivered to the energy store, where it is stored. In order to achieve recuperation, the electric motor, when in the generator mode, can reduce or decelerate the rotational speed of the chainring or belt cog or of the rotor, wherein, as a result, electrical energy is obtained, which electrical energy is delivered to the energy store and is stored. The recuperation can be initiated, for example, by pedaling the pedals backwards, which even further increases the riding safety.

The aforementioned definitions and comments regarding technical effects, advantages, and advantageous embodiments of the operating unit according to the invention according to the first aspect of the invention also apply by analogy to the method according to the invention for activating a bottom bracket drive of an electric bicycle and for the electric bicycle according to the invention according to the third aspect of the invention, and vice versa. It is to be understood that features of the approaches described above and in the claims and/or with respect to the figures can also be optionally combined in order to be able to cumulatively implement the advantages and effects which are achievable in the present case.

### BRIEF DESCRIPTION OF THE DRAWINGS

In the following, a preferred exemplary embodiment of the invention is explained in greater detail with reference to the two figures, wherein identical or similar elements are provided with the same reference characters. Wherein:

FIG. 1 shows a schematic side view of an electric bicycle according to the invention having a bottom bracket drive according to the invention and an operating unit according to one preferred embodiment,

FIG. 2 shows a highly simplified schematic view of a first actuating element of the operating unit according to the invention from FIG. 1, and

FIG. 3 shows a highly simplified schematic view of a second actuating element of the operating unit according to the invention from FIG. 1 and FIG. 2.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

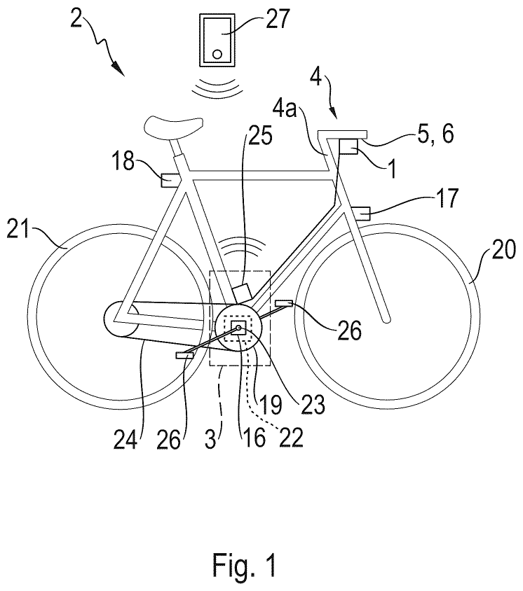

FIG. 1 shows an electric bicycle 2 including a front wheel 20 and a rear wheel 21, which rear wheel 21 is operatively connected via a chain 24 to a bottom bracket drive 3 located in the bottom bracket region of the electric bicycle 2. The electric bicycle 2 is a bicycle having electric assistance (pedelec) and a derailleur. The bottom bracket drive 3 has a chainring 19 via which the chain 24 is drivable. The bottom bracket drive 3 also has a control device 25, which is connected to an operating unit 1 and a propulsion unit 16 of the bottom bracket drive 3 for control purposes. The bottom bracket drive 3 is supplied with electrical energy via a battery (not shown here) for propelling the electric bicycle 2, which electrical energy is supplied to the bottom bracket drive 3 in a manner which is not described in greater detail. The bottom bracket drive 3 also includes a transmission 22 which is, for example, a shiftable planetary transmission, which transmission 22 is operatively connected at least indirectly to a crank axle 23 of the electric bicycle 2 via a first transmission element and at least indirectly to a chainring 19 of the electric bicycle 2 via a second transmission element. The bottom bracket drive 3 also includes means for decoupling a kinematic energy from the chainring 19, which kinematic energy is usable for recuperation. The sole purpose here is to illustrate that the bottom bracket drive 3 is designed for recuperation. The recuperation is carried out, for example, by pedaling backwards on pedals 26, which are connected to the crank axle 23 for conjoint rotation, or by pulling on a brake lever (also not shown here).

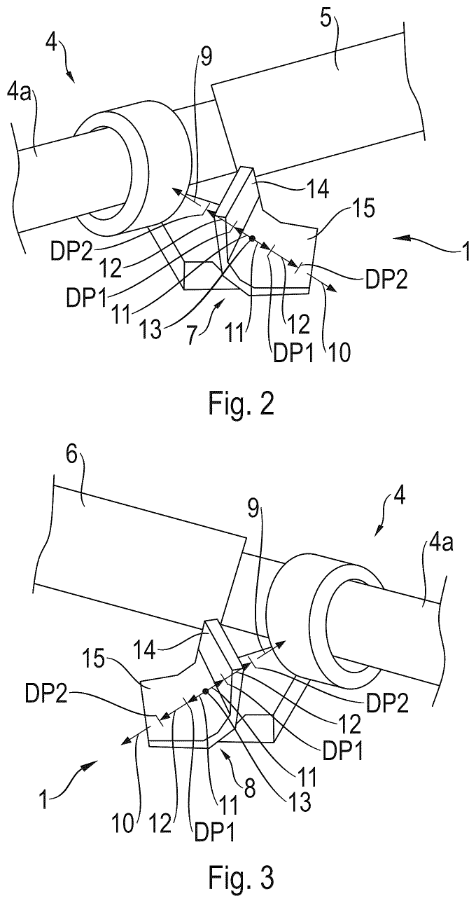

The electric bicycle 2 has a handlebar 4 including two handlebar grips 5, 6 attached to a handlebar frame 4a. The operating unit 1 is attached to the handlebar frame 4a in the region of (near or at) the handlebar grips 5, 6. The configuration and the mode of operation of the operating unit 1 and a method according to the invention for activating the bottom bracket drive 3 are described in greater detail in the following with reference to FIG. 2 and FIG. 3.

According to FIG. 2 and FIG. 3, the operating unit 1 has a first actuating element 7 and a second actuating element 8. FIG. 2 shows the first actuating element 7, which is attached in the region of the right handlebar grip 5 and is actuatable, for example, using the thumb of the right hand of the bicycle rider. FIG. 3 shows the second actuating element 8, which is attached in the region of the left handlebar grip 6 and is actuatable, for example, using the thumb of the left hand of the bicycle rider.

Each actuating element 7, 8 is movable from a neutral position 13 by the respective thumb of the bicycle rider in a first actuation direction 9 and in a dissimilar, second actuation direction 10. The particular actuating element 7, 8 is movable from the neutral position 13 in either of the two actuation directions 9, 10 into two functional positions 11, 12, which are arranged one after the other in the particular actuation direction 9, 10. The particular actuating element 7, 8 returns to the neutral position 13 when released. In the particular actuation direction 9, 10, a pressure point, which is noticeable by the bicycle rider, is provided between the two functional positions 11, 12. A first actuating force is necessary to reach the first functional position 11. In contrast, in order to reach the second functional position 12, the first pressure point, which is indicated here by a first dash DP1, is to be overcome by applying a second actuating force, which is greater in comparison to the first actuating force. In other words, the first pressure point is not overcome during an actuation of the particular actuating element 7, 8 in the particular actuation direction 9, 10 when the particular actuating element 7, 8 is actuated using the first actuating force. At the end of the second functional position, a second pressure point is provided, which is indicated here by a second dash DP2. Since only two functional positions 11, 12 are provided in this exemplary embodiment, the second pressure point DP2 cannot be overcome. When three or more functional positions are provided, the second pressure point DP2 and, if applicable, further pressure points, is overcome using a certain, respective actuating force. The first actuating element 7 is a gear shifter and the second actuating element 8 is a mode change switch.

In the present case, the actuating elements 7, 8 are each a shift rocker, wherein a first leg 14 of the shift rocker is actuatable in the first actuation direction 9, and wherein a second leg 15 of the shift rocker, which is integrally connected to the first leg 14, is actuatable in the second actuation direction 10.

The bottom bracket drive 3 is activatable according to an actuation of the first actuating element 7 such that the bottom bracket drive 3 is upshifted in a stepwise manner by one gear step in each case by repeatedly: actuating the first actuating element 7 from the neutral position 13 into the first functional position 11 in the first actuation direction 9 and, immediately thereafter, releasing the first actuating element 7, and such that the bottom bracket drive 3 is downshifted in a stepwise manner by one gear step in each case by repeatedly: actuating the first actuating element 7 from the neutral position 13 into the first functional position 11 in the second actuation direction 10 and, immediately thereafter, releasing the first actuating element 7. Thus, the bicycle rider initiates single-gear shifts, i.e., an upshift or a downshift by one gear step, by briefly tapping the first actuating element 7 into the first functional position 11 in the particular actuation direction 9, 10.

In addition, the bottom bracket drive 3 is activatable according to an actuation of the first actuating element 7 such that the bottom bracket drive 3 is upshifted in a stepwise manner by, in this case for example, two gear steps by repeatedly: actuating the first actuating element 7 from the neutral position 13 into the second functional position 12 in the first actuation direction 9 and, immediately thereafter, releasing the first actuating element 7, and such that the bottom bracket drive 3 is downshifted in a stepwise manner by two gear steps by repeatedly: actuating the first actuating element 7 from the neutral position 13 into the second functional position 12 in the second actuation direction 10 and, immediately thereafter, releasing the first actuating element 7. Thus, the bicycle rider initiates double gear shifts by briefly tapping the first actuating element 7 according to the actuation direction 9, 10 into the second functional position 12. In other words, either two gears, or “gear steps”, are upshifted or downshifted by each actuation of the first actuating element 7 into the second functional position 12. Triple gear shifts, quadruple gear shifts, or other multiple-gear shifts are also conceivable depending on the transmission 22.

Furthermore, the first actuating element 7, once it has been brought into the first or the second functional position 11, 12 in the particular actuation direction 9, 10, is held in this position, wherein either an input command, in this case to carry out a gear shift by one or more gear step(s), is implemented after a certain time, or wherein the same input command, i.e., a gear shift by one or more gear step(s), is carried out again and again at certain intervals. Thus, the bottom bracket drive 3 is activatable according to an actuation of the first actuating element 7 such that the bottom bracket drive 3 is upshifted by three or more gear steps by actuating the first actuating element 7 from the neutral position 13 into the first functional position 11 and/or the second functional position 12 in the first actuation direction 9 and holding the first actuating element 7 in the first and/or the second functional position 11, 12 for a defined duration, and such that the bottom bracket drive 3 is downshifted by three or more gear steps by actuating the first actuating element 7 from the neutral position 13 into the first functional position 11 and/or the second functional position 12 in the second actuation direction 10 and holding the first actuating element 7 in the first and/or the second functional position 11, 12 for a defined duration. If the first actuating element 7 is held in the first functional position 11 in the particular actuation direction 9, 10, single gear shifts are carried out again and again in certain time intervals, for example, 500 ms or 1000 ms. If the first actuating element 7 is held in the second functional position 11 in the particular actuation direction 9, 10, multiple gear shifts are carried out again and again in certain time intervals, for example, 500 ms or 1000 ms. For this purpose, a display unit (not shown here) is located on the handlebar, which display unit displays to the bicycle rider the target gear which they set as well as the current actual gear.

The riding and operating mode of the electric bicycle 2 is influenced by the second actuating element 8. Using the second actuating element 8, functions influencing the operating mode of the electric bicycle 2 are influenced. A particular function influencing the operating mode of the electric bicycle 2 is the adjustment or selection of a defined propulsion assistance by an electric machine as the propulsion unit 16, which is drivingly connected to the bottom bracket drive 3, the adjustment or selection of a recuperation level of the bottom bracket drive 3, the selection of a shifting characteristic in the bottom bracket drive 3, the activation or deactivation of a walk-assist function of the electric bicycle 2, and/or the activation or deactivation of a front headlight 17 and/or taillight 18 of the electric bicycle 2. Depending on the configuration of the second actuating element 8, these functions are implementable according to the actuation direction 9, 10 and the duration of the actuation. An exemplary button and pressure point assignment is explained in the following.

The bottom bracket drive 3 is activatable according to an actuation of the second actuating element 8 such that a function influencing the operating mode of the electric bicycle 2 is adjustable and/or activatable by actuating the second actuating element 8 from the neutral position 13 into the first functional position 11 and/or the second functional position 12 in the first actuation direction 9 and, thereafter, releasing the second actuating element 8, and such that the function influencing the operating mode of the electric bicycle 2 is adjustable and/or deactivatable by actuating the second actuating element 8 from the neutral position 13 into the first functional position 11 and/or the second functional position 12 in the second actuation direction 10 and, thereafter, releasing the second actuating element 8.

Thus, the bicycle rider adjusts, for example, an intensity of an electric-motor assistance by briefly tapping the second actuating element 8 into the first functional position 11 in the particular actuation direction 9, 10. Consequently, the bottom bracket drive 3 is activatable according to an actuation of the second actuating element 8 such that a progressive increase of a propulsive power of the bottom bracket drive 3 by one step is adjustable by repeatedly: actuating the second actuating element 8 from the neutral position 13 into the first functional position 11 in the first actuation direction 9 and, thereafter, releasing the second actuating element 8, and such that a progressive decrease of the propulsive power of the bottom bracket drive 3 by one step is adjustable by repeatedly: actuating the second actuating element 8 from the neutral position 13 into the first functional position 11 in the second actuation direction 10 and, thereafter, releasing the second actuating element 8. Furthermore, the bicycle rider adjusts, for example, a shifting characteristic for the transmission 22, by briefly tapping the second actuating element 8 into the second functional position 11 in the particular actuation direction 9, 10. In the process, it is possible to shift, for example, between a sporty shifting characteristic, a comfortable shifting characteristic, and an energy-saving shifting characteristic. The shifting characteristics are configurable as desired. In particular, shifting characteristics are adaptable to the rider's own riding behavior or the preferences of the bicycle rider.

Furthermore, the second actuating element 8, once it has been brought into the first or the second functional position 11, 12 in the particular actuation direction 9, 10, is held in this position, wherein an input command, in this case to adjust, activate, or deactivate a function influencing the operating mode of the electric bicycle 2, is implemented after a certain time. Thus, the bottom bracket drive 3 is activatable according to an actuation of the second actuating element 8 such that a further function influencing an operating mode of the electric bicycle 2 is adjustable or activatable by actuating the second actuating element 8 from the neutral position 13 into the first functional position 11 and/or the second functional position 12 in the first actuation direction 9 and holding the second actuating element 8 in the first functional position 11 and/or the second functional position 12 for a defined duration, and such that the further function related to the operating mode or the manner of use of the electric bicycle 2 is adjustable or deactivatable by actuating the second actuating element 8 from the neutral position 13 into the first functional position 11 and/or the second functional position 12 in the second actuation direction 10 and holding the second actuating element 8 in the first functional position 11 and/or the second functional position 12 for a defined duration. If the second actuating element 8 is held in the first functional position 11 in the particular actuation direction 9, 10 for a certain duration, for example, a front headlight 17 and a taillight 18 of the electric bicycle 2 are activated or switched on (first functional position 11 in the first actuation direction 9), or, when it has already been switched on, then switched off again (first functional position 11 in the second actuation direction 10). This command is, for example, input when the bicycle rider holds the second actuating element 8 in the first functional position 11 in the particular actuation direction 9, 10 for, for example, 1000 ms.

If the second actuating element 8 is held in the second functional position 12 in the particular actuation direction 9, 10 for a certain duration, for example, a walk-assist function or start-up assist function of the electric bicycle 2 is activated or switched on (second functional position 12 in the first actuation direction 9), or, when the walk-assist function or start-up assist function has already been switched on, then switched off again (second functional position 12 in the second actuation direction 10). This command is, for example, input when the bicycle rider holds the second actuating element 8 in the second functional position 12 in the particular actuation direction 9, 10 for, for example, 1000 ms.

FIG. 1 also shows the control device 25. The control device 25 communicates with an external device, in this case a smartphone 27 of the bicycle rider, wherein configurations on the operating unit 1, in particular on the button and pressure point assignment, are implemented by the smartphone 27. The aforementioned functions and button assignments are interchangeable in any way. It is also conceivable that the second actuating force required to overcome the first pressure point is adjustable. Furthermore, it is possible to adjust the holding duration for which the particular actuating element 7, 8 must be held in the particular functional position in the particular actuation direction 9, 10 until the input command is transmitted to the control device 25 or until the control device 25 carries out a corresponding activation at the bottom bracket drive 3.

The advantages of such an operating unit 1 are that it is intuitively operated. In particular, multiple operating modes or different gear changes are implementable using only two thumb positions on the particular actuating element 7, 8. In addition, the riding safety is increased, since the hands are always on the handlebar. The particular thumb needs to move only slightly away from the position of the optimal grip on the handlebar. In addition, various additional functions such as adjusting a shifting characteristic, are also implementable, which additional functions are also adjustable using the particular actuating element 7, 8.

The preceding exemplary embodiments are intended to make it clear that an intuitive, practically blind operation of the operating unit 1 is possible by reducing the number of buttons and by a clever arrangement, combination, and button assignment. The actuating elements 7, 8 are located on the particular handlebar grip 5, 6 such that the rider actuates these elements 7, 8 using the particular thumb without moving the particular hand away from the handlebar grip 5, 6. It is conceivable that both actuating elements 7, 8 are jointly located next to one another on the left or the right handlebar grip 5, 6, so that the bottom bracket drive 3 is activatable using only one hand.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 operating unit
2 electric bicycle
3 bottom bracket drive
4 handlebar
4a handlebar frame
5 first handlebar grip
6 second handlebar grip
7 first actuating element
8 second actuating element
9 first actuation direction
10 second actuation direction
11 first functional position
12 second functional position
13 neutral position
14 first leg
15 second leg
16 propulsion unit or electric machine
17 front headlight
18 taillight
19 chainring
20 front wheel
21 rear wheel
22 transmission
23 crank axle
24 chain
25 control device
26 pedal
27 smartphone
DP1 first dash
DP2 second dash cm. 1-15. canceled

16. An operating unit (1) for a bottom bracket drive (3) of an electric bicycle (2), the operating unit (1) being attachable to a handlebar (4) of the electric bicycle (2) at a handlebar grip (5, 6), the operating unit (1) comprising:
at least one actuating element (7, 8), each particular actuating element of the at least one actuating element (7, 8) being movable, starting from a neutral position (13), in either a first actuation direction (9) or in a second actuation direction (10) at a time by a finger of a user, the second actuation direction (10) being different from the first actuation direction (9), each particular actuating element (7, 8) being movable, in either of the first actuation direction (9) or the second actuation direction (10), from the neutral position (13) into at least two functional positions (11, 12), the at least two functional positions being arranged one after another, each particular actuating element returning to the neutral position (13) when released, a first actuating force being required to move the particular actuating element into a first functional position (11) of the at least two functional positions, and a second actuating force being required to overcome a noticeable pressure point and to move the particular actuating element into at least one second functional position (12) of the at least two functional positions, the second actuating force being greater than the first actuating force.

17. The operating unit (1) of claim 16, wherein the at least one actuating element comprises a first actuating element (7),
wherein the bottom bracket drive (3) is stepwise upshifted by one gear step each time the first actuating element (7) is moved from the neutral position (13) into the first functional position (11) in the first actuation direction (9) and, immediately thereafter, released to return towards the neutral position (13), and
wherein the bottom bracket drive (3) is stepwise downshifted by one gear step each time the first actuating element (7) is moved from the neutral position (13) into the first functional position (11) in the second actuation direction (10) and, immediately thereafter, released to return towards the neutral position (13).

18. The operating unit (1) of claim 16, wherein the at least one actuating element comprises a first actuating element (7),
wherein the bottom bracket drive (3) is stepwise upshifted by two or more gear steps each time the first actuating element (7) is moved from the neutral position (13) into the second functional position (12) in the first actuation direction (9) and, immediately thereafter, released to return towards the neutral position (13), and
wherein the bottom bracket drive (3) is stepwise downshifted by two or more gear steps each time the first actuating element (7) is moved from the neutral position (13) into the second functional position (12) in the second actuation direction (10) and, immediately thereafter, released to return towards the neutral position (13).

19. The operating unit (1) of claim 16, wherein the at least one actuating element (7,8) comprises a first actuating element (7),
wherein the bottom bracket drive (3) is upshifted by three or more gear steps by actuating the first actuating element (7) from the neutral position (13) into one of the first functional position (11) or the second functional position (12) in the first actuation direction (9) and holding the first actuating element (7) in the one of the first functional position (11) or the second functional position (12) in the first actuation direction (9) for a first defined duration, and
wherein the bottom bracket drive (3) is downshifted by three or more gear steps by actuating the first actuating element (7) from the neutral position (13) into one of the first functional position (11) or the second functional position (12) in the second actuation direction (10) and holding the first actuating element (7) in the one of the first functional position (11) or the second functional position (12) in the second actuation direction (10) for a second defined duration.

20. The operating unit (1) of claim 16, wherein the at least one actuating element (7,8) comprises a second actuating element (8), and
wherein the bottom bracket drive (3) is activatable according to an actuation of the second actuating element (8) such that:
a function influencing an operating mode of the electric bicycle (2) is adjustable or activatable by actuating the second actuating element (8) from the neutral position (13) into one of the at least two functional positions (11, 12) in the first actuation direction (9) and, thereafter, releasing the second actuating element (8), and
the function being adjustable or deactivatable by actuating the second actuating element (8) from the neutral position (13) into one of the at least two functional positions (11, 12) in the second actuation direction (10) and, thereafter, releasing the second actuating element (8).

21. The operating unit (1) of claim 20, wherein the bottom bracket drive (3) is activatable according to the actuation of the second actuating element (8) such that:
a further function influencing a further operating mode or manner of use of the electric bicycle (2) is adjustable or activatable by actuating the second actuating element (8) from the neutral position (13) into one of the at least two functional positions (11, 12) in the first actuation direction (9) and holding the second actuating element (8) in the one of the at least two functional positions (11, 12) in the first actuation direction (9) for a first defined duration,
the further function being adjustable or deactivatable by actuating the second actuating element (8) from the neutral position (13) into one of the at least two functional positions (11, 12) in the second actuation direction (10) and holding the second actuating element (8) in one of the at least two functional positions (11, 12) in the second actuation direction (10) for a second defined duration.

22. The operating unit (1) of claim 16, wherein one or more of the at least one actuating element (7, 8) is a shift rocker, a first leg (14) of the shift rocker being actuatable in the first actuation direction (9), and a second leg (15) of the shift rocker being actuatable in the second actuation direction (10), the second leg (15) being integrally connected to the first leg (14).

23. A method for activating a bottom bracket drive (3) of an electric bicycle (2), the method comprising:
providing an operating unit (1) for activating the bottom bracket drive (3), the operating unit comprising at least one actuating element (7, 8), each particular actuating element of the at least one actuating element (7, 8) being movable, starting from a neutral position (13), in either a first actuation direction (9) or in a second actuation direction (10) at a time by a finger of a user, the second actuation direction (10) being different from the first actuation direction (9), each particular actuating element (7, 8) being movable, in either of the first actuation direction (9) or the second actuation direction (10), from the neutral position (13) into at least two functional positions (11, 12), the at least two functional positions being arranged one after another, each particular actuating element returning to the neutral position (13) when released, a first actuating force being required to move the particular actuating element into a first functional position (11) of the at least two functional positions, and a second actuating force being required to overcome a noticeable pressure point and to move the particular actuating element into at least one second functional position (12) of the at least two functional positions, the second actuating force being greater than the first actuating force.

24. The method of claim 23, wherein providing the at least one actuating element comprises providing a first actuating element (7),
the method further comprising:
performing a stepwise upshift of the bottom bracket drive (3) by one gear each time the first actuating element (7) is moved from the neutral position (13) into the first functional position (11) in the first actuation direction (9) and, immediately thereafter, released to return to the neutral position (13), and
performing a stepwise downshift of the bottom bracket drive (3) by one gear step each time the first actuating element (7) is moved from the neutral position (13) into the first functional position (11) in the second actuation direction (10) and, immediately thereafter, released to return to the neutral position (13).

25. The method of claim 23, wherein providing the at least one actuating element comprises providing a first actuating element (7),
the method further comprising:
performing a stepwise upshift of the bottom bracket drive (3) by two or more gear steps each time the first actuating element (7) is moved from the neutral position (13) into the second functional position (12) in the first actuation direction (9) and, immediately thereafter, released to return to the neutral position (13), and
performing a stepwise downshift of the bottom bracket drive (3) by two or more gear steps each time the first actuating element (7) is moved from the neutral position (13) into the second functional position (12) in the second actuation direction (10) and, immediately thereafter, released to return to the neutral position (13).

26. The method of one of claim 23, wherein providing the at least one actuating element comprises providing a first actuating element (7),
the method further comprising:
upshifting the bottom bracket drive (3) by three or more gear steps each time the first actuating element (7) is moved from the neutral position (13) into one of the first functional position (11) or the second functional position (12) in the first actuation direction (9) and held in the one of the first functional position (11) or the second functional position (12) in the first actuation direction (9) for a first defined duration, and
downshifting the bottom bracket drive (3) by three or more gear steps each time the first actuating element (7) is moved from the neutral position (13) into one of the first functional position (11) or the second functional position (12) in the second actuation direction (10) and held in the one of the first functional position (11) or the second functional position (12) in the second actuation direction (10) for a second defined duration.

27. The method of one of claim 23, wherein providing the at least one actuating element comprises providing a second actuating element (8),
wherein the bottom bracket drive (3) is activated according to an actuation of the second actuating element (8) such that the method further comprises:
adjusting or activating a function influencing an operating mode of the electric bicycle (2) when the second actuating element (8) is moved from the neutral position (13) into one of the at least two functional positions (11, 12) in the first actuation direction (9) and, thereafter, released to return to the neutral position (13),
adjusting or deactivating the function when the second actuating element (8) is moved from the neutral position (13) into one of the at least two functional positions (11, 12) in the second actuation direction (10) and, thereafter, released to return to the neutral position (13).

28. The method of claim 27, further comprising:
adjusting or activating a further function influencing a further operating mode or manner of use of the electric bicycle (2) when the second actuating element (8) is moved from the neutral position (13) into one of the at least two functional positions (11, 12) in the first actuation direction (9) and held in the one of the at least two functional positions (11, 12) in the first actuation direction (9) for a first defined duration,
adjusting or deactivating the further function when the second actuating element (8) is moved from the neutral position (13) into one of the at least two functional positions (11, 12) in the second actuation direction (10) and held in the one of the at least two functional positions (11, 12) in the second actuation direction (10) for a second defined duration.

29. The method of claim 27, wherein the function includes one or more of:
adjusting or selecting a defined propulsion assistance by an electric machine (16), the electric machine (16) being drivingly connected to the bottom bracket drive (3);
adjusting or selecting a recuperation level of the bottom bracket drive (3);
selecting a shifting characteristic in the bottom bracket drive (3);
activating or deactivating a walk-assist function of the electric bicycle (2); or
activating or deactivating a front headlight (17) and/or a tail light (18) of the electric bicycle (2).

30. An electric bicycle (2), comprising:
a handlebar (4) having two handlebar grips (5, 6);
a front wheel (20);
a rear wheel (21);
a bottom bracket drive (3), one or both of the front wheel (20) or the rear wheel (21) being at least indirectly drivingly connected to the bottom bracket drive (3); and
the operating unit (1) of claim 16 on the handlebar (4), the operating unit (1) being at least indirectly electronically connected to the bottom bracket drive (3).
